(19) United States
(12) Patent Application Publication
(10) Pub. No.: US 2006/0018635 A1
(43) Pub. Date: Jan. 26, 2006

(54) Optical disk, optical disk drive, and optical disk recording method

(76) Inventor: Tadashi Kobayashi, Chiba-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/187,851

(22) Filed: Jul. 25, 2005

(30) Foreign Application Priority Data
Jul. 26, 2004 (JP) 2004-217597

(51) Int. Cl. H04N 5/781

(52) U.S. Cl. 386/126

(57) ABSTRACT

An optical disk comprises a first information recording layer including a first inward test recording area and a first outward test recording area, and a second information recording layer including a second inward test recording area and a second outward test recording area, wherein at least one recording management area is formed in at least one of the first information recording layer and the second information recording layer and records recording management information which is obtained when test recording is performed for at least one of the first and the second inward test recording areas and the first and the second outward test recording areas.

### CROSS-REFERENCE TO RELATED APPLICATIONS

This application is based upon and claims the benefit of priority from prior Japanese Patent Application No. 2004-217597, filed Jul. 26, 2004, the entire contents of which are incorporated herein by reference.

### BACKGROUND OF THE INVENTION

1. Field of the Invention

The present invention relates to an optical disk, such as a DVD (Digital Versatile Disk), and more particularly to a multi-layered optical disk having improved information recording layers.

The present invention also relates to an optical disk drive and an optical disk recording method for recording information in the multi-layered optical disk.

2. Description of the Related Art

As is well known, the technology for recording information with high density is being developed in recent years, and recent optical disks include a disk having a storage capacity of 4.7 GB (Giga Byte) on one side thereof. Such an optical disk is realized as DVD-R (recordable DVD), DVD-RW (rewritable DVD), DVD-RAM (random access memory), or the like.

At the present time, information is recorded on an optical disk at a speed several times faster than the standard recording speed (linear velocity) (3.49 m/s) defined for an ordinary type of optical disk.

To enhance the recording density, the optical disk may be provided with information recording layers arranged at multi-levels.

Jpn. Pat. Appln. KOKAI Publication No. 2001-184642 discloses how to prevent the erasing of data when it is recorded by a read modify write process.

However, Jpn. Pat. Appln. KOKAI Publication No. 2001-184642 does not disclose a technology for speeding up the recording speed of an optical disk. Nor does that reference disclose a technology for providing multi-layered optical disk.

### BRIEF SUMMARY OF THE INVENTION

Accordingly, an object of the present invention is to provide an optical disk, an optical disk drive and an optical disk recording method, which optimize the recording conditions for each information recording layer of a multi-layered optical disk in accordance with the recording speed.

To achieve the above object, the present invention provides an optical disk comprising a first information recording layer including a first inward test recording area and a first outward test recording area; and
a second information recording layer including a second inward test recording area and a second outward test recording area, wherein at least one recording management area is formed in at least one of the first information recording layer and the second information recording layer and records recording management information which is obtained when test recording is performed for at least one of the first and the second inward test recording areas and the first and the second outward test recording areas.

The present invention also provides an optical disk drive used with an optical disk comprising a first information recording layer including a first inward test recording area and a first outward test recording area; and a second information recording layer including a second inward test recording area and a second outward test recording area, wherein at least one recording management area is formed in at least one of the first information recording layer and the second information recording layer and records recording management information which is obtained when test recording is performed for at least one of the first and the second inward test recording areas and the first and the second outward test recording areas, the optical disk drive comprising:
first control means for (i) determining recording conditions by performing test recording for one of the first inward test recording area and the first outward test recording area in accordance with a requested recording speed when a request for recording information in the first information recording layer is made, (ii) recording the information in the first information recording layer based on the determined recording conditions, and (iii) recording management information, obtained when the test recording is performed for one of the first inward test recording area and the first outward test recording area, in the recording management area; and
second control means for (i) determining recording conditions by performing test recording for one of the second inward test recording area and the second outward recording area in accordance with a requested recording speed when a request for recording information in the second information recording layer is made, (ii) recording the information in the second information recording layer based on the determined recording conditions, and (iii) recording management information, obtained when the test recording is performed for one of the second inward test recording area and the second outward test recording area, in the recording management area.

The present invention further provides an optical disk recording method for an optical disk comprising a first information recording layer including a first inward test recording area and a first outward test recording area; and a second information recording layer including a second inward test recording area and a second outward test recording area, wherein at least one recording management area is formed in at least one of the first information recording layer and the second information recording layer and records recording management information which is obtained when test recording is performed for at least one of the first and the second inward test recording areas and the first and the second outward test recording areas, the method comprising:
a first step of determining recording conditions by performing test recording for one of the first inward test recording area and the first outward test recording area in accordance with a requested recording speed when a request for recording information in the first information recording layer is made;
a second step of (i) recording the information in the first information recording layer based on the recording conditions determined in the first step, and (ii) recording management information, obtained when the test recording is performed for one of the first inward test recording area and the first outward test recording area, in the recording management area;
a third step of determining recording conditions by performing test recording for one of the second inward test recording area and the second outward test recording area in accordance with a requested recording speed when a request for recording information in the second information recording layer is made; and
a fourth step of (i) recording the information in the second information recording layer based on the recording conditions determined in the third step, and (ii) recording management information, obtained when the test recording is performed for one of the second inward test recording area and the second outward test recording area, in the recording management area.

Additional advantages of the invention will be set forth in the description which follows, and in part will be obvious from the description, or may be learned by practice of the invention. The advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block circuit diagram illustrating an optical disk drive and an optical disk which are according to an embodiment of the present invention;

FIGS. 2A, 2B, and 2C illustrate a PTP type optical disk that is used with the optical disk drive according to the embodiment;

FIG. 3 is a flowchart illustrating part of the optical disk recording operation according to the embodiment;

FIG. 4 is a flowchart illustrating the remaining part of the optical disk recording operation according to the embodiment;

FIGS. 5A, 5B, and 5C illustrate an OTP type optical disk that is used with the optical disk drive according to the embodiment;

FIGS. 6A, 6B, and 6C illustrate the OTP type optical disk of the embodiment in which the radial positions of middle areas are changed;

FIG. 7 is a flowchart illustrating part of the OTP type optical disk recording operation the embodiment; and

FIG. 8 is a flowchart illustrating the remaining part of the OTP type optical disk recording operation of the embodiment.

### DETAILED DESCRIPTION OF THE INVENTION

An embodiment of the present invention will now be described in detail with reference to the accompanying drawings.

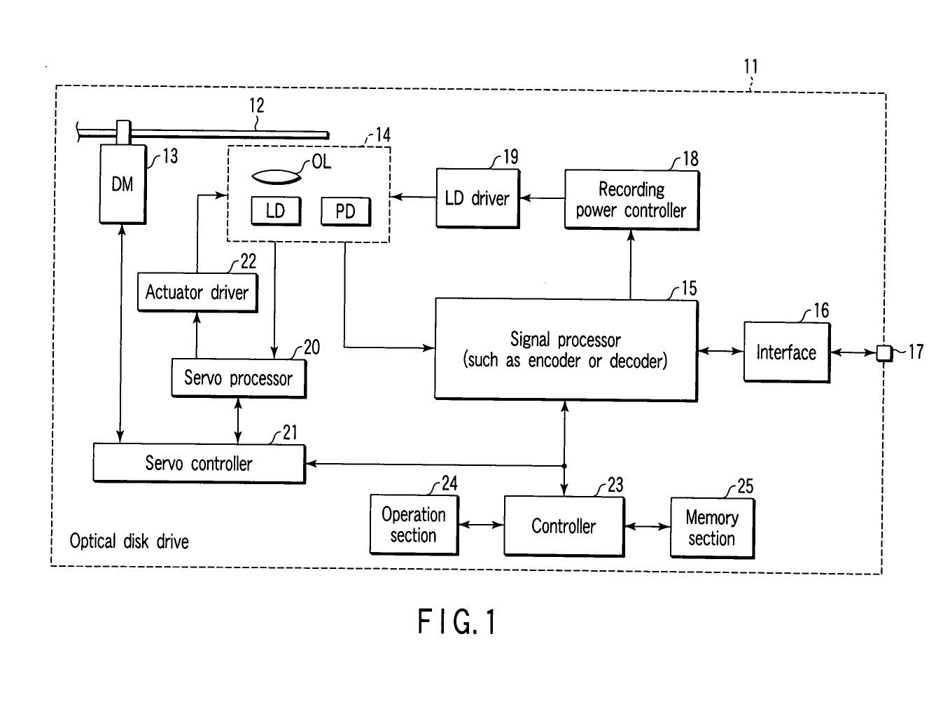

FIG. 1 shows an optical disk drive 11 and an optical disk 12 which are according to an embodiment of the present invention.

The optical disk 12 is a multi-layered recordable DVD having information recording layers. The optical disk 12 is rotated by a disk motor 12 at a predetermined speed. An optical head 14 is opposed to one of the surfaces of the optical disk 12.

The optical head 14 reads information out of the optical disk 12 and is movable in the radial direction of the optical disk 12.

To be more specific, the optical head 14 reads information out of the optical disk 12 as follows:

The optical head 14 has an objective lens OL. By this objective lens, a laser beam a laser diode LD emits for the reproduction of information is focused on a target information recording layer of the optical disk 12. The reflected beam is incident on a photodiode PD, by which it is converted into electric signals. The electric signals output from the photodiode PD are supplied to a signal processor 15.

In the signal processor 15, the electric signals are subjected to digitizing, predetermined decode processing, error correction processing and descramble processing.

After being subjected to these kinds of processing, the electric signals are supplied through an interface 16 to an input/output terminal 17, from which they are output and used for the reproduction of video and audio information.

The optical head 14 can also write information in the optical disk 12 by focusing a recording laser beam on a target information recording layer of the optical disk 12. The recording laser beam is emitted from the laser diode LD and is focused on the target recording layer by the objective lens OL. To be more specific, the write operation is performed as follows:

First, information to be written in the optical disk 12 is input from the input/output terminal 17. The input information is supplied through the interface 16 to the signal processor 15.

The signal processor 15 performs predetermined processing with respect to the input recording information, including encode processing, processing for adding error-correction codes and scramble processing. After being subjected to these kinds of processing, the recording information is supplied to a recording power controller 18.

The recording power controller 18 determines appropriate recording conditions in accordance with the recording speed at which the information is to be recorded in the optical disk. Based on the determined recording conditions, the recording power controller 18 controls an LD driver 19 so that an appropriate amount of light can be emitted from the laser diode LD. In this manner, the information can be recorded under the appropriate recording conditions determined in accordance with the recording speed.

The electric signals output from the photodiode PD of the optical head 14 are supplied to a servo processor 20.

Under the control by a servo controller 21, the servo processor 20 generates error signals from the electric signals. The error signals correspond to a tracking error or a focusing error of the objective lens OL.

Based on the error signals the servo processor 20 generates, an actuator driver 22 controls the objective lens OL in both the tracking direction and focusing direction. Controlled in this manner, the objective lens OL performs a tracking servo operation and a focusing servo operation. The servo controller 21 also controls the rotation of a disk motor 13.

All operations of the optical disk drive 11, including the recording/reproduction operations described above, are controlled by a controller 23.

The controller 23 incorporates a CPU (a central processing unit) or the like. Upon receipt of control information supplied from an operation section 24, the controller 23 performs control operations in accordance with the control information.

When performing control, the controller 23 uses a memory section 25.

The memory section 25 includes: a read-only memory which stores control programs the CPU of the controller 23 executes; a read/write memory which the CPU uses as a work area; and a nonvolatile memory which stores various types of setting information and control information.

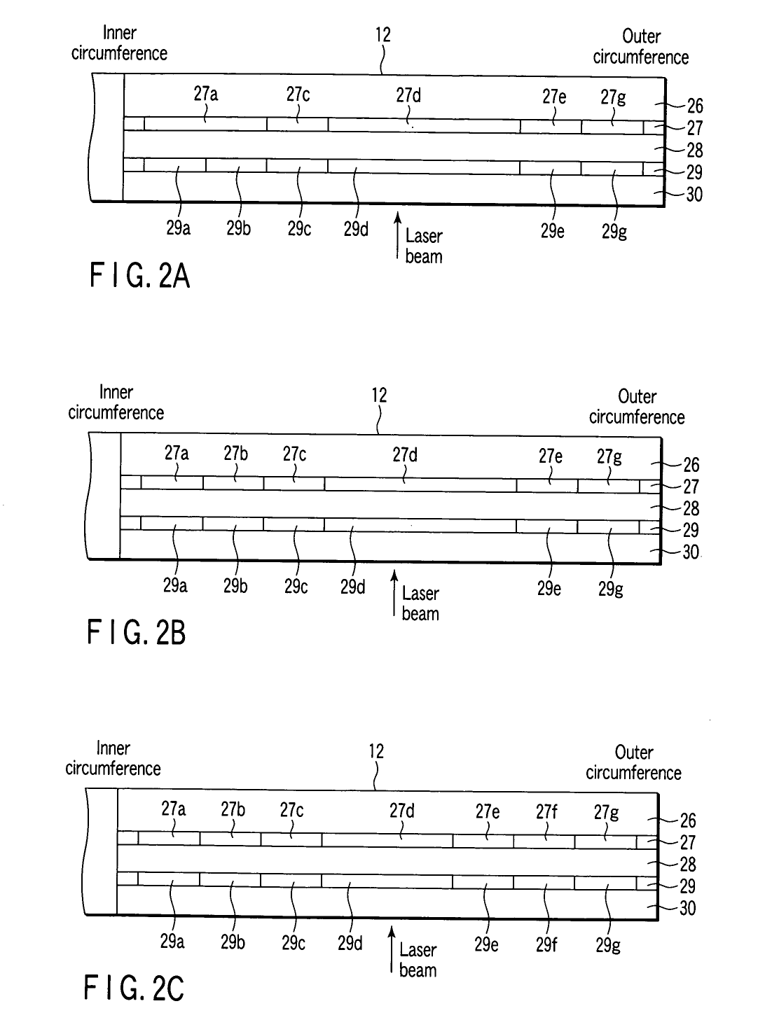

FIG. 2A shows details of the optical disk 12.

The optical disk 12 comprises a circular substrate 26 made of polycarbonate. An information recording layer 27 made of a metallic material, an intermediate layer 28 made of a transparent material, an information recording layer 29 made of a semi-transparent material, and a cover layer 30 made of a transparent material are stacked on one side of the substrate 26 in the order mentioned.

A laser beam emitted from the optical head 14 is incident on the cover layer 30, as indicated by the arrow in FIG. 2A, and is selectively focused on one of the two information recording layers 29 and 27.

The optical disk 12 is a PTP (parallel track path) type. That is, each of the two information recording layers 29 and 27 starts the recording/reproduction of information from a radially-inward area to a radially-outward area. To be more specific, information recording layer 29 (the first information recording layer), which is closer to the optical head 14 than information recording layer 27 is, includes a radially-inward test recoding area (PCA) 29a, a recording management area (RMA) 29b, a lead-in area 29c, an information recording area 29d, a lead-out area 29e and a radially-outward test recording area (PCA) 29g. These areas are sequentially formed from the innermost circumferential position of information recording layer 29 to the outermost circumferential position thereof.

Likewise, information recording layer 27 (the second information recording layer), which is farther from the optical head 14 than information recording layer 29 is, includes a radially-inward test recoding area (PCA) 27a, a lead-in area 27c, an information recording area 27d, a lead-out area 27e and a radially-outward test recording area (PCA) 29g. These areas are sequentially formed from the innermost circumferential position of information recording layer 27 to the outermost circumferential position thereof.

A description will now be given as to how information is recorded in the information recording area 29d of the first information recording layer 29 at the standard speed (i.e., 3.49 m/s) or at a speed slower than the quadruple speed (which is four times faster than the standard speed). In this case, the optical disk 12 is rotated until the recording linear speed of the radially-inward test recording area 29a becomes appropriate for recording.

Then, a predetermined signal is test-recorded in the radially-inward test recording area 29a.

The test-recorded signal is read, and appropriate recording conditions are determined and set. Based on the appropriate conditions, information is recorded in the information recording area 29d.

Subsequently, recording management information is recorded in the recording management area 29b. The recording management information includes (i) address information used for the test recording and indicating a position in the radially-inward test recording area 29a, and (ii) the recording conditions that have been set (including information regarding a used optical disk, a recording speed, recording power, a recording signal waveform).

In this manner, the information is recorded in the information recording layer 29.

A description will now be given as to how information is recorded in the information recording area 29d of the first information recording layer 29 at a speed higher than the quadruple speed (e.g., at the 8× speed). In this case, the optical disk 12 is rotated until the recording linear speed of the radially-outward test recording area 29g becomes appropriate for recording.

Then, a predetermined signal is test-recorded in the radially-outward test recording area 29g.

The test-recorded signal is read, and appropriate recording conditions are determined and set. Based on the appropriate conditions, information is recorded in the information recording area 29d.

Subsequently, recording management information is recorded in the recording management area 29b. The recording management information includes (i) address information used for the test recording and indicating a position in the radially-inward test recording area 29g, and (ii) the recording conditions that have been set.

In this manner, the information is recorded in the information recording layer 29.

A description will now be given as to how information is recorded in the information recording area 27d of the second information recording layer 27 at the standard speed or at a speed slower than the quadruple speed. In this case, the optical disk 12 is rotated until the recording linear speed of the radially-inward test recording area 27a becomes appropriate for recording.

Then, a predetermined signal is test-recorded in the radially-inward test recording area 27a.

The test-recorded signal is read, and appropriate recording conditions are determined and set. Based on the appropriate conditions, information is recorded in the information recording area 27d.

Subsequently, recording management information is recorded in the recording management area 29b. The recording management information includes (i) address information used for the test recording and indicating a position in the radially-inward test recording area 27a, and (ii) the recording conditions that have been set.

In this manner, the information is recorded in the information recording layer 27.

A description will now be given as to how information is recorded in the information recording area 27d of the second information recording layer 27 at a speed faster than the quadruple speed (e.g., at the 8× speed). In this case, the optical disk 12 is rotated until the recording linear speed of the radially-outward test recording area 27g becomes appropriate for recording.

Then, a predetermined signal is test-recorded in the radially-outward test recording area 27g.

The test-recorded signal is read, and appropriate recording conditions are determined and set. Based on the appropriate conditions, information is recorded in the information recording area 27d.

Subsequently, recording management information is recorded in the recording management area 29b. The recording management information includes (i) address information used for the test recording and indicating a position in the radially-outward test recording area 27g, and (ii) the recording conditions that have been set.

In this manner, the information is recorded in the information recording layer 27.

In the embodiment described above, information recording layer 29 includes radially-inward test recording area 29a and radially-outward test recording area 29g, and information recording layer 27 includes radially-inward test recording area 27a and radially-outward test recording area 27g. When information is recorded in information recording layer 29, either radially-inward test recording area 29a or radially-outward test recording area 29g is used in accordance with the recording speed. Likewise, when information is recorded in information recording layer 27, either radially-inward test recording area 27a or radially-outward test recording area 27g is used in accordance with the recording speed.

Because of the selective use of the radially-inward and radially-outward test recording areas, information can be recorded under the recording conditions suitable for the characteristics of the recording films constituting the information recording layers 29 and 27. Hence, the recording conditions used for the information recording layers 29 and 27 can be optimized in accordance with the recording speeds. In addition, the recording management information, obtained when signals are test-recorded in the radially-inward test recording areas 29a and 27a and the radially-outward test recording areas 29g and 27g, is recorded in the recording management area 29b of the first information recording layer 29. Thus, the recording conditions corresponding to the information recording layers 29 and 27 and according with the recording speeds can be acquired by merely referring to the recording information stored in the recording management area 29b. This is very convenient when information is additionally recorded on the write-once recording medium (DVD-R).

Information can be recorded in the information recording layers 29 and 27 as follows. That is, a radial position is predetermined on the optical disk 12. Where information is recorded in areas that are inward of the radial position with respect to the predetermined radial position, a low-speed recording mode is selected. Where information is recorded in areas that are outward of the radial position, a high-speed recording mode is selected. In the low-speed recording mode, the radially-inward test recording areas 29a and 27a of the information recording layers 29 and 27 may be used. In the high-speed recording mode, the radially-outward test recording areas 29g and 27g of the information recording layers 29 and 27 may be used. In either recording mode, the recording management information is stored in the recording management area 29b of the first information recording layer 29.

FIG. 2B shows a modification of the PTP type optical disk 12 shown in FIG. 2A. In FIG. 2B, the same reference numerals as used in FIG. 2A denote corresponding or similar structural elements.

In the modification shown in FIG. 2B, information recording layer 27 (the second information recording layer) includes a radially-inward test recoding area 27a, a recording management area 27b, a lead-in area 27c, an information recording area 27d, a lead-out area 27e and a radially-outward test recording area 27g. These areas are sequentially formed from the innermost circumferential position of information recording layer 27 to the outermost circumferential position thereof.

In other words, information recording layers 29 and 27 have recording management areas 29b and 27b, respectively.

When signals are test-recorded in the radially-inward and radially-outward test recording areas 29a and 29g of the first information recording layer 29, recording management information obtained then is recorded in the recording management area 29b of the same information recording layer 29.

Likewise, when signals are test-recorded in the radially-inward and radially-outward test recording areas 27a and 27g of the second information recording layer 27, recording management information obtained then is recorded in the recording management area 27b of the same information recording layer 27.

In the modification, each of the information recording layers 29 and 27 is provided with a recording management area 29b or 27b in which recording management information obtained at the time of test recording is stored. With this structure, radially-inward and radially-outward test recording areas 29a and 29g can be managed by using recording management area 29b provided for information recording layer 29, and radially-inward and radially-outward test recording areas 27a and 27g can be managed by using recording management area 27b provided for information recording layer 27.

Owing to this feature, recorded information can be managed based on the characteristics of the recording films constituting the information recording layers 29 and 27.

FIG. 2C shows a modification of the PTP type optical disk 12 shown in FIG. 2B. In FIG. 2C, the same reference numerals as used in FIG. 2B denote corresponding or similar structural elements.

In this modification, information recording layer 29 (the first information recording layer) includes a radially-inward test recoding area 29a, a recording management area 29b, a lead-in area 29c, an information recording area 29d, a lead-out area 29e, a recording management area (RMA) 29f and a radially-outward test recording area 29g. These areas are sequentially formed from the innermost circumferential position of information recording layer 29 to the outermost circumferential position thereof.

When signals are test-recorded in the radially-inward test recording area 29a, the recording management information obtained then is recorded in recording management area 29b.

When signals are test-recorded in the radially-outward test recording area 29g, the recording management information obtained then is recorded in recording management area 29f.

Information recording layer 27 (the second information recording layer) includes a radially-inward test recoding area 27a, a recording management area 27b, a lead-in area 27c, an information recording area 27d, a lead-out area 27e, a recording management area (RMA) 27f and a radially-outward test recording area 27g. These areas are sequentially formed from the innermost circumferential position of information recording layer 27 to the outermost circumferential position thereof.

When signals are test-recorded in the radially-inward test recording area 27a, the recording management information obtained then is recorded in recording management area 27b.

When signals are test-recorded in the radially-outward test recording area 27g, the recording management information obtained then is recorded in recording management area 27f.

In the modification shown in FIG. 2C, each information recording layer 29 (27) has two recording management areas 29b (27b) and 29f (27f), one being used for the radially-inward test recording area 29a (27a) and the other being used for the radially-outward test recording area 29g (27g).

With this structure as well, recorded information can be managed based on the characteristics of the recording films constituting the information recording layers 29 and 27.

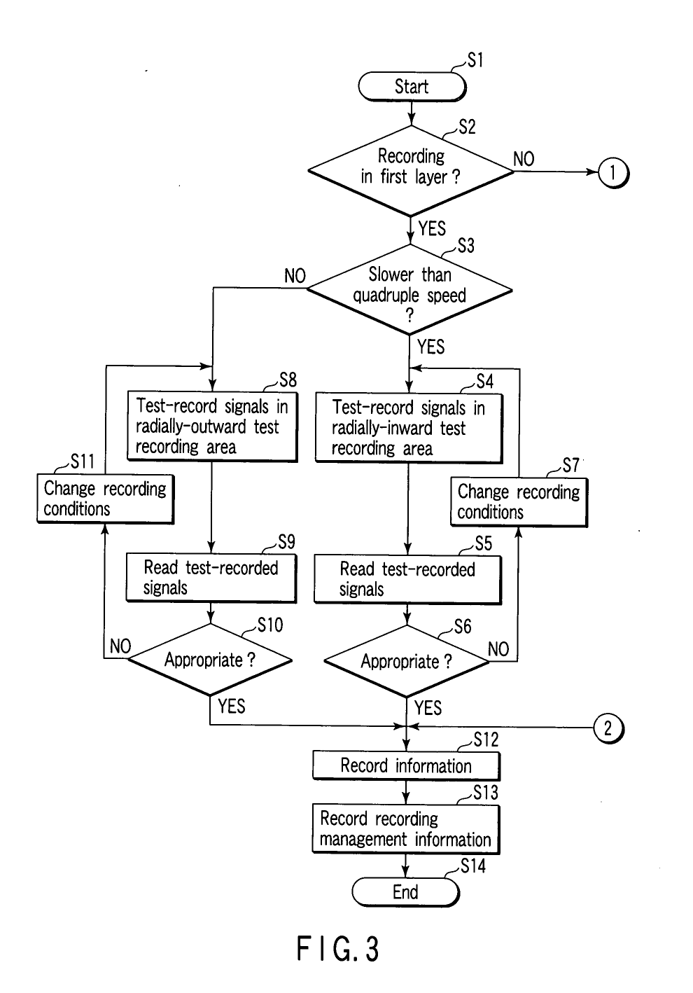

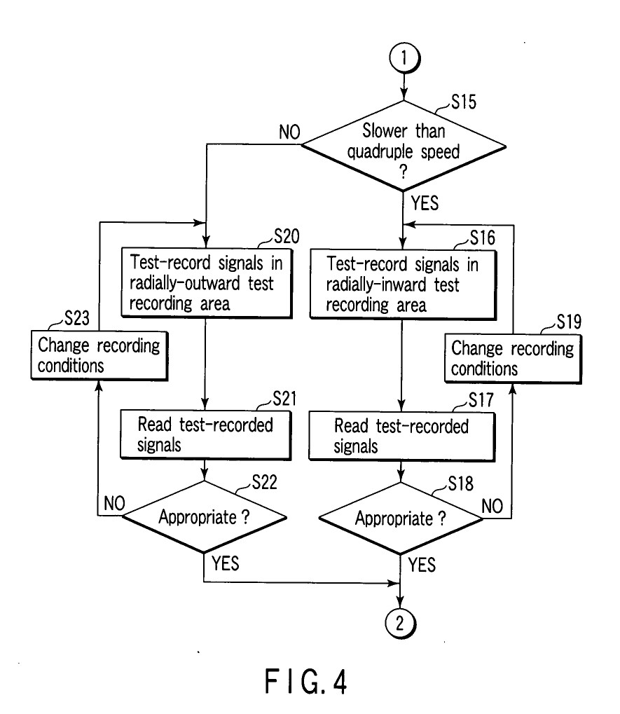

FIGS. 3 and 4 are flowcharts illustrating the recording operation performed for the PTP type optical disk 12 described above.

When processing is started (S1), it is determined whether the controller 23 requests the recording of information in the first information recording layer 29 (S2).

When it is determined that the recording of information in the first information recording layer 29 is requested (S2-YES), the controller 23 determines whether the requested recording speed is slower than the quadruple speed, which is four times faster than the standard linear recording speed (S3).

When it is determined that the requested recording speed is lower than the quadruple speed (S3-YES), then the controller 23 test-records signals in the radially-inward test recording area 29a of information recording layer 29 (S4). The test-recorded signals are read (S5), and a check is made to see whether the read signals are appropriate (S6).

If the check shows that the read signals are not appropriate (S6-NO), recording conditions are changed, and the flow returns to Step S4 (S7).

When it is determined in Step S3 that the requested recording speed is higher than the quadruple speed (which is four times faster than the standard linear recording speed) (S3-NO), then the controller 23 test-records signals in the radially-outward test recording area 29g of information recording layer 29 (S8).

The test-recorded signals are read (S9), and a check is made to see whether the read signals are appropriate (S10).

If the check shows that the read signals are not appropriate (S10-NO), recording conditions are changed, and the flow returns to Step S8 (S11).

If the signals read in Step S6 or Step S10 are determined to be appropriate (S6-YES, S10-YES), the controller 23 records information in the information recording area 29d of the information recording layer (in this case, layer 29) at the requested recording speed (S12). The information is recorded on the basis of the recording conditions under which the read signals are determined to be appropriate.

Thereafter, the controller 23 records recording management information in the recording management area 29b or 29f (S13). The recording management information includes (i) address information used for the test recording and indicating a position in the test recording area 29a or 29g; and (ii) recording conditions that have been set.

In this manner, the processing is completed (S14).

When it is determined that the recording of information in the first information recording layer 29 is not requested (S2-NO), the controller 23 determines that the recording of information in the second information recording layer 27 is requested. Based on this determination, the controller 23 determines whether the requested recording speed is slower than the quadruple speed (Si5).

When it is determined that the requested recording speed is slower than the quadruple speed (S15-YES), then the controller 23 test-records signals in the radially-inward test recording area 27a of information recording layer 27 (S16). The test-recorded signals are read (S17), and a check is made to see whether the read signals are appropriate (S18).

If the check shows that the read signals are not appropriate (S18-NO), recording conditions are changed, and the flow returns to Step S16 (S19).

When it is determined in Step S15 that the requested recording speed is faster than the quadruple speed (S15-NO), then the controller 23 test-records signals in the radially-outward test recording area 27g of information recording layer 27 (S20).

The test-recorded signals are read (S21), and a check is made to see whether the read signals are appropriate (S22).

If the check shows that the read signals are not appropriate (S22-NO), recording conditions are changed, and the flow returns to Step S20 (S23).

If the signals read in Step S18 or Step S22 are determined to be appropriate (S18-YES, S22-YES), the controller 23 records information in the information recording area 27d of the information recording layer (in this case, layer 27) at the requested recording speed (S12). The information is recorded on the basis of the recording conditions under which the read signals are determined to be appropriate.

Thereafter, the controller 23 records recording management information in the recording management area 29b, 27b or 27f (S13). The recording management information includes (i) address information used for the test recording and indicating a position in the test recording area 27a or 27g; and (ii) recording conditions that have been set.

In this manner, the processing is completed (Step S14).

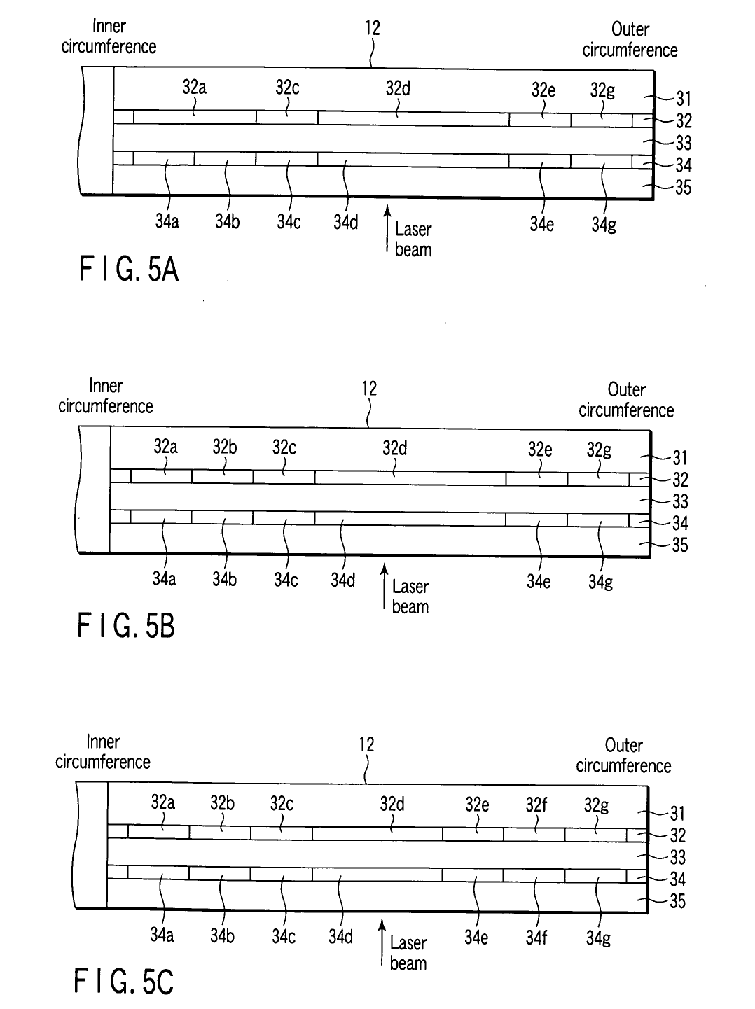

FIG. 5A shows another example of the optical disk 12 described above.

The optical disk 12 comprises a circular substrate 31 made of polycarbonate. An information recording layer 32 made of a metallic material, an intermediate layer 33 made of a transparent material, an information recording layer 34 made of a semi-transparent material, and a cover layer 35 made of a transparent material are stacked on one side of the substrate in the order mentioned.

A laser beam emitted from the optical head 14 is incident on the cover layer 35, as indicated by the arrow in FIG. 5A, and is selectively focused on the two information recording layers 34 and 32.

The optical disk 12 is an OTP (opposite track path) type. That is, information recording layer 34 (the first information recording layer), which is closer to the optical head 14 than information recording layer 32 is, starts the recording/reproduction of information from a radially-inward area to a radially-outward area, and information recording layer 32 (the second information recording layer), which is farther from the optical head 14 than information recording layer 34 is, starts the recording/reproduction of information from a radially-outward area to a radially-inward area.

To be more specific, information recording layer 34 (the first information recording layer) includes a radially-inward test recoding area (PCA) 34a, a recording management area (RMA) 34b, a lead-in area 34c, an information recording area 34d, a middle area 34e, and a radially-outward test recording area (PCA) 34g. These areas are sequentially formed from the innermost circumferential position of information recording layer 34 to the outermost circumferential position thereof.

Information recording layer 32 (the second information recording layer) includes a radially-outward test recoding area (PCA) 32g, a middle area 32e, an information recording area 32d, a lead-out area 32c, and a radially-inward test recording area (PCA) 32a. These areas are sequentially formed from the outermost circumferential position of information recording layer 32 to the innermost circumferential position thereof.

Recording management information is recorded in the recording management area 34b of the information recording layer 34. The recording management information includes (i) information obtained when signals are test-recorded in the radially-inward and radially-outward test recording areas 34a and 34g of the first information recording layer 34, and (ii) information obtained when signals are test-recorded in the radially-inward and radially-outward test recording areas 32a and 32g of the second information recording layer 32.

FIG. 5B shows a modification of the OTP type optical disk 12 shown in FIG. 5A. In FIG. 5B, the same reference numerals as used in FIG. 5A denote corresponding or similar structural elements.

In this modification, information recording layer 32 (the second information recording layer) includes a radially-outward test recoding area 32g, a middle area 32e, an information recording area 32d, a lead-out area 32c, a recording management area (RMA) 32b and a radially-inward test recording area 32a. These areas are sequentially formed from the outermost circumferential position of information recording layer 32 to the outermost circumferential position thereof.

In the modification, recording management areas 34b and 32b are provided for information recording layers 34 and 32, respectively.

When signals are test-recorded in the radially-inward and radially-outward test recording areas 34a and 34g of the first information recording layer 34, recording management information obtained then is recorded in the recording management area 34b of the same information recording layer 34.

Likewise, when signals are test-recorded in the radially-inward and radially-outward test recording areas 32a and 32g of the second information recording layer 32, recording management information obtained then is recorded in the recording management area 32b of the same information recording layer 32.

FIG. 5C shows a modification of the OTP type optical disk 12 shown in FIG. 5B. In FIG. 5C, the same reference numerals as used in FIG. 5B denote corresponding or similar structural elements.

In this modification, information recording layer 34 (the first information recording layer) includes a radially-inward test recoding area 34a, a recording management area 34b, a lead-in area 34c, an information recording area 34d, a middle area 34e, a recording management area (RMA) 34f and a radially-outward test recording area 34g. These areas are sequentially formed from the innermost circumferential position of information recording layer 34 to the outermost circumferential position thereof.

When signals are test-recorded in the radially-inward test recording area 34a, the recording management information obtained then is recorded in recording management area 34b. When signals are test-recorded in the radially-outward test recording area 34g, the recording management information obtained then is recorded in recording management area 34f.

Information recording layer 32 (the second information recording layer) includes a radially-inward test recoding area 32g, a recording management area (RMA) 32f, a middle area 32e, an information recording area 32d, a lead-out area 32c, a recording management area 32b and a radially-outward test recording area 32a. These areas are sequentially formed from the outermost circumferential position of information recording layer 32 to the innermost circumferential position thereof.

When signals are test-recorded in the radially-inward test recording area 32a, the recording management information obtained then is recorded in recording management area 32b. When signals are test-recorded in the radially-outward test recording area 32g, the recording management information obtained then is recorded in recording management area 32f.

In other words, each information recording layer 34 (32) has two recording management areas 34b (32b) and 34f (32f), one being used for the radially-inward test recording area 34a (32a) and the other being used for the radially-outward test recording area 34g (32g).

The radial positions of the middle areas 34e and 32e of the information recording layers 34 and 32 may be arbitrarily determined.

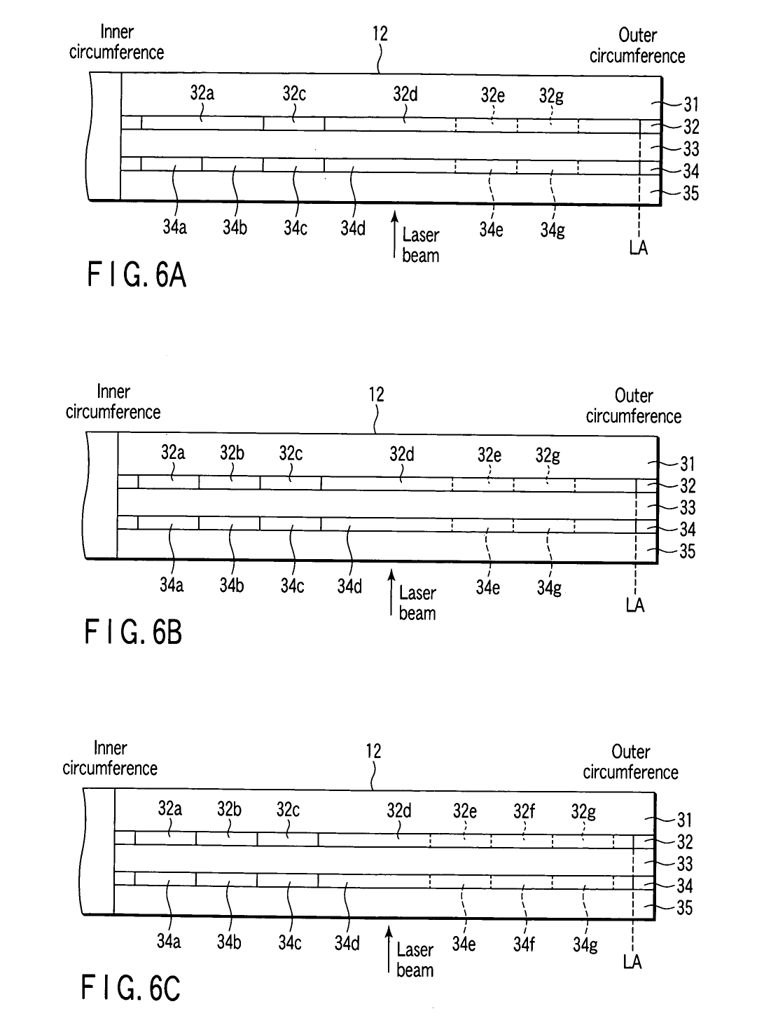

FIG. 6A shows an optical disk wherein the middle areas 34e and 32e are more radially inward than those of the optical disk 12 shown in FIG. 5A, as indicated by the broken lines.

In the case shown in FIG. 6A, the middle areas 34e and 32e are at the same radial position of the optical disk 12.

When signals are test-recorded in the radially-inward test recording area 32a, the recording management information obtained then is recorded in recording management area 32b. When signals are test-recorded in the radially-outward test recording area 32g, the recording management information obtained then is recorded in recording management area 32f.

The radial positions of the radially-outward test recording areas 34g and 32g are determined by the radial position of the middle areas 34e and 32e.

Of the areas of the information recording layers 34 and 32, those areas which are radially outward of the test recording layers 34g and 32g are not used for recording information.

As can be seen from the above, the radial positions of the middle areas 34e and 32e are determined depending upon whether all areas of the optical disk 12 are used for the recording/reproduction of information. To be more specific, the optical disk 12 warps less at the inner circumferential portions than at the outer circumferential portions. Therefore, using only the inner circumferential portions of the disk leads to reliable and stable recording and reproduction.

There may be a case where the outer circumferential portions of the optical disk 12 are not used for the recording/reproduction of information.

FIG. 6B shows an optical disk wherein the middle areas 34e and 32e are more radially inward than those of the optical disk 12 shown in FIG. 5B, as indicated by the broken lines. In the optical disk 12 shown in FIG. 6B as well, the middle areas 34e and 32e are at the same radial position of the optical disk 12. The radial positions of the radially-outward test recording areas 34g and 32g are determined by the radial position of the middle areas 34e and 32e.

Of the areas of the information recording layers 34 and 32, those areas which are radially outward of the test recording layers 34g and 32g are not used for recording information.

FIG. 6C shows an optical disk wherein the middle areas 34e and 32e are more radially inward than those of the optical disk 12 shown in FIG. 5C, as indicated by the broken lines. In the optical disk 12 shown in FIG. 6C as well, the middle areas 34e and 32e are at the same radial position of the optical disk 12. The radial positions of the radially-outward test recording areas 34g and 32g are determined by the radial position of the middle areas 34e and 32e. Of the areas of the information recording layers 34 and 32, those areas which are radially outward of the test recording layers 34g and 32g are not used for recording information.

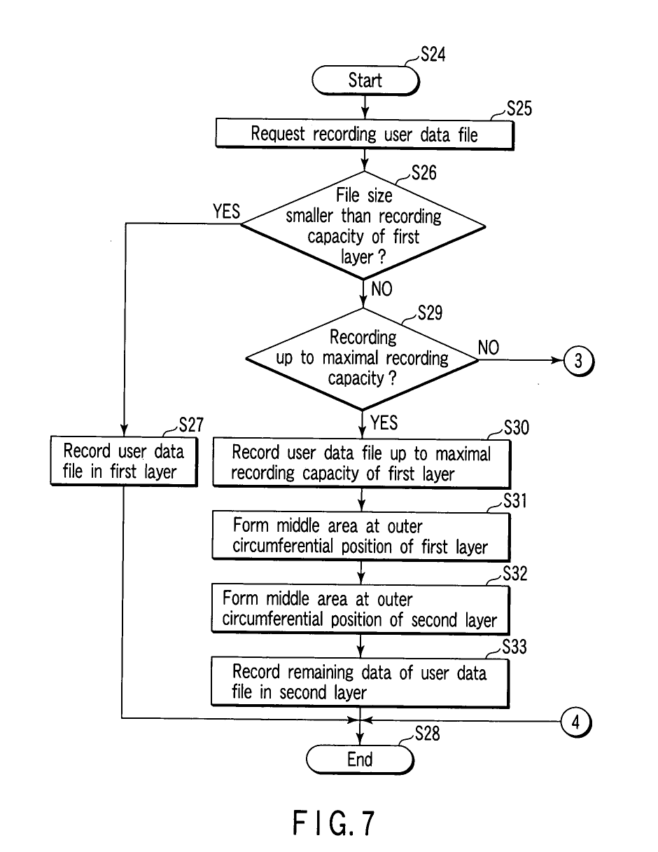

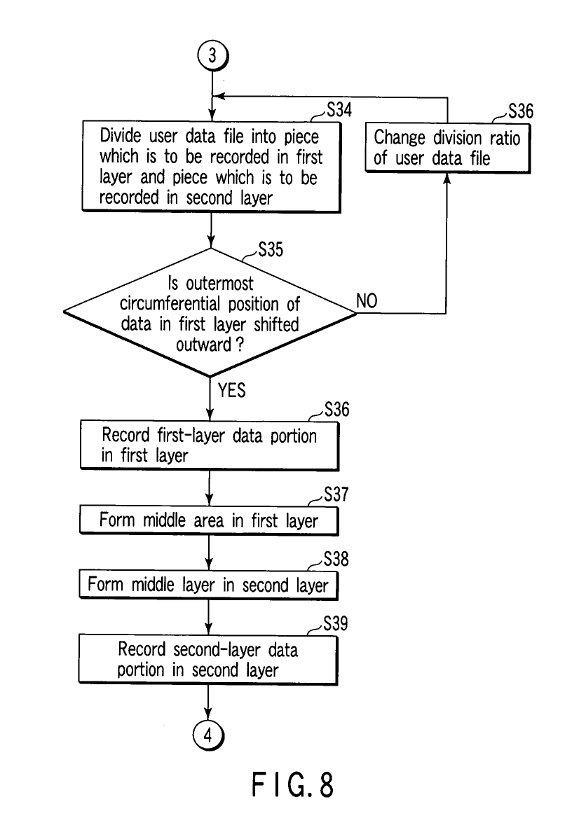

FIGS. 7 and 8 are flowcharts illustrating how to determine the positions of the middle areas 34e and 32e in accordance with the amount of information to be recorded.

Referring to the flowcharts, processing is started (S24), and when the recording of a user data file (information) is requested (S25), the controller 23 checks whether or not the file size (i.e., the amount of information) of the user data file is smaller than the recording capacity of the recordable portion of the information recording area 34d of the first information recording layer 34 (S26).

If the check shows that the file size is smaller than the recording capacity (S26-YES), the user data file is recorded in the information recording area 34d, and the processing is ended (S28).

If the check in step S26 shows that the file size (i.e., the amount of information) of the user data file is smaller than the recording capacity of the recordable portion of the information recording area 34d of the first information recording layer 34 (S26-NO), the controller 23 determines whether the user data file should be recorded up to the maximal recording capacity of the recordable portion of the information recording area 34d of the first information recording layer 34 (S29).

If the controller 23 determines that the user data file should be recorded up to the maximal recording capacity of the recordable portion of the information recording area 34d of the first information recording layer 34 (S29-YES), the user data file is recorded up to the maximum recording capacity (S30).

Then, the controller 23 forms middle area 34e (recording management area 34f, and radially-outward test recording area 34g) at the outermost circumferential position of the first information recording layer 34 (S31).

Subsequently, the controller 23 forms middle area 32e (recording management area 32f and radially-outward test recording area 32g) at the outermost circumferential position of the second information recording layer 32 (S32). Middle areas 34e and 32e are formed at the same radial position of the optical disk 12.

Thereafter, the controller 23 records the remaining information of the user data file in the information recording area 32d of the second information recording layer 32 from the middle area 32e toward the read-out area 32c (S33).

In this manner, the processing is ended (S28).

If the controller 23 does not determine that the user data file should be recorded up to the maximal recording capacity of the recordable portion of the information recording area 34d of the first information recording layer 34 (S29-NO), the controller 23 divides the user data file into two pieces, one of which is to be recorded in the information recording area 34d of the first information recording layer 34 and the other of which is to be recorded in the information recording area 32d of the second information recording layer 32 (S34).

Then, the controller 23 determines whether the outermost circumferential position of the data recorded in the information recording area 34d of the first information recording layer 34 is more radially outward from the outermost circumferential position of the data recorded in the information recording area 32d of the second information recording layer 32 by a predetermined distance (S35).

If the controller 23 determines that the outermost circumferential position of the data recorded in the information recording area 34d of the first information recording layer 34 is not more radially outward (S35-NO), then the controller 23 changes the division ratio, and the flow returns to the processing of Step S34 (S36).

If the controller 23 determines in Step S35 that the outermost circumferential position of the data recorded in the information recording area 34d of the first information recording layer 34 is more radially outward (S35-YES), the controller 23 records the user data file portion corresponding to the first information recording layer 34 in the information recording area 34d of the information recording layer 34 from the inner circumferential portions toward the outer circumferential portions (S36).

After recording the user data file portion corresponding to the first information recording layer 34, the controller 23 forms middle area 34e (recording management area 34f and radially-outward test recording area 34g) (S37).

Then, the controller 23 forms middle area 32e (recording management area 32f and radially-outward test recording area 32g) in the second information recording layer 32 in such a manner that middle area 32e is at the same radial position as middle area 34e formed in the first information recording layer 34 (S38).

Thereafter, the controller 23 records the remaining data of the user data file in the information recording area 32d of the second information recording layer 32 (S39). The remaining data is recorded from the middle area (32e) side toward the lead-out area (32c) side.

In this manner, the processing is ended (S28).

Where the middle areas 34e and 32e are formed radially inward, the recording management areas 34f and 32f, the radially-outward test recording areas 34g and 32g, etc. are also formed radially inward, accordingly.

In other words, where the middle areas 34e and 32e are located toward the center of the disk, the areas that are radially outward of the test recording areas 34g and 32g of the information recording layers 34 and 32 are unused areas, and information of any kind, including signals to be test-recorded, is not recorded in those areas.

Where the middle areas 34g and 32g are located toward the center of the disk, the radially-outward test recording areas 34g and 32g are controlled in such a way that they are not outward of the outermost limit position LA shown in FIG. 6. Data can be recorded in those areas of the information recording layers 34 and 32 which are radially inward of the outermost limit position LA.

The present invention is not limited to the embodiment and modifications described above. When the present invention is reduced to practice, its structural elements can be modified in various ways without departing from the spirit and scope of the invention. In addition, various inventions can be produced by properly combining the structural elements of the aforesaid embodiment. For example, some of the structural elements of the embodiment may be deleted. In addition, the structural elements of different embodiments may be combined.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An optical disk comprising:
a first information recording layer including a first inward test recording area and a first outward test recording area; and
a second information recording layer including a second inward test recording area and a second outward test recording area,
wherein at least one recording management area is formed in at least one of the first information recording layer and the second information recording layer and records recording management information which is obtained when test recording is performed for at least one of the first and the second inward test recording areas and the first and the second outward test recording areas.

2. The optical disk according to claim 1, wherein two recording management areas are formed in the first information recording layer and the second information recording layer, respectively.

3. The optical disk according to claim 2, wherein
the two recording management areas comprises a first recording management area formed in the first information recording layer and a second recording management area formed in the second information recording layer,
the first recording management area includes a first inward recording management subarea for recording management information which is obtained when test recording is performed for the first inward test recording areas and a first outward recording management subarea for recording management information which is obtained when test recording is performed for the first outward test recording areas, and
the second recording management area includes a second inward recording management subarea for recording management information which is obtained when test recording is performed for the second inward test recording areas and a second outward recording management subarea for recording management information which is obtained when test recording is performed for is the second outward test recording areas.

4. The optical disk according to claim 3, wherein
the first inward test recording area is located at an innermost circumferential position of the first information recording layer, and
the second inward test recording area is located at an innermost circumferential position of the second information recording layer.

5. The optical disk according to claim 1, wherein
the first information recording layer includes the first inward test recording area, the first recording management area, a lead-in area, an information recording area, a lead-out area and the first outward test recording area, which are sequentially formed from an inner circumferential position to an outer circumferential position, and
the second information recording layer includes the second inward test recording area, the second recording management area, a lead-in area, an information recording area, a lead-out area and the second outward test recording area, which are sequentially formed from an inner circumferential position to an outer circumferential position.

6. The optical disk according to claim 1, wherein
the first information recording layer includes the first inward test recording area, the first recording management area, a lead-in area, an information recording area, a middle area and the first outward test recording area, which are sequentially formed from an inner circumferential position to an outer circumferential position, and
the second information recording layer includes the second inward test recording area, a middle area, an information recording area, lead-out area, the second recording management area and the second outward test recording area, which are sequentially formed from an inner circumferential position to an outer circumferential position.

7. An optical disk drive used with an optical disk comprising a first information recording layer including a first inward test recording area and a first outward test recording area; and a second information recording layer including a second inward test recording area and a second outward test recording area, wherein at least one recording management area is formed in at least one of the first information recording layer and the second information recording layer and records recording management information which is obtained when test recording is performed for at least one of the first and the second inward test recording areas and the first and the second outward test recording areas, the optical disk drive comprising:
first control means for (i) determining recording conditions by performing test recording for one of the first inward test recording area and the first outward test recording area in accordance with a requested recording speed when a request for recording information in the first information recording layer is made, (ii) recording the information in the first information recording layer based on the determined recording conditions, and (iii) recording management information, obtained when the test recording is performed for one of the first inward test recording area and the first outward test recording area, in the recording management area; and
second control means for (i) determining recording conditions by performing test recording for one of the second inward test recording area and the second outward recording area in accordance with a requested recording speed when a request for recording information in the second information recording layer is made, (ii) recording the information in the second information recording layer based on the determined recording conditions, and (iii) recording management information, obtained when the test recording is performed for one of the second inward test recording area and the second outward test recording area, in the recording management area.

8. The optical disk drive according to claim 7, wherein
two recording management areas are formed in the first information recording layer and the second information recording layer,
the two recording management areas comprises a first recording management area formed in the first information recording layer and a second recording management area formed in the second information recording layer,
the first control means records recording management information, obtained when the test recording is performed for one of the first inward test recording area and the first outward test recording area, in the first recording management area, and
the second control means records recording management information, obtained when the test recording is performed for one of the second inward test recording area and the outward test recording area, in the second recording management area.

9. The optical disk drive according to claim 7, wherein
the first information recording layers has a first inward recording management area and a first outward recording management area, and the second information recording layers has a second inward recording management area and a second outward recording management area,
the first control means records recording management information, obtained when the test recording is performed for the first inward test recording area, in the first inward recording management area,
the first control means records recording management information, obtained when the test recording is performed for the first outward test recording area, in the first outward recording management area,
the second control means records recording management information, obtained when the test recording is performed for the second inward test recording area, in the second inward recording management area, and
the second control means records recording management information, obtained when the test recording is performed for the second outward test recording area, in the second outward recording management area.

10. The optical disk drive according to claim 7, wherein
the first control means performs the test recording in the first inward test recording area when a request is made for recording information in the first information recording layer at a low speed, the low speed being slower than a speed that is a predetermined times faster than a standard speed,
the first control means performs the test recording in the first outward test recording area when a request is made for recording information in the first information recording layer at a high speed, the high speed being faster than a speed that is predetermined times faster than the standard speed,
the second control means performs the test recording in the second inward test recording area when a request is made for recording information in the second information recording layer at said low speed, and
the second control means performs the test recording in the second outward test recording area when a request is made for recording information in the second information recording layer at said high speed.

11. The optical disk drive according to claim 7, wherein the first and second control means records recording management information in the recording management area, the recording management information including (i) address information of one of the test recording areas used for the test recording, and (ii) information representing the determined recording conditions.

12. The optical disk drive according to claim 7, further comprising third control means for dividing recording information into a first information piece which is to be recorded in the first information recording layer and a second information piece which is to be recorded in the second information recording layer, and wherein
the first control means records the first information piece in the first information recording layer from an inner circumferential position to an outer circumferential position, and forms a middle area from a position where recording of the first information piece ends,
the second control means forms a middle area in the second information recording layer at a region corresponding to the middle area formed in the first information recording layer, starts recording the second information piece in the second information recording layer at the position of the middle area, and continues recording the second information piece from an outer circumferential position to an inner circumferential position.

13. An optical disk recording method for an optical disk comprising a first information recording layer including a first inward test recording area and a first outward test recording area; and a second information recording layer including a second inward test recording area and a second outward test recording area, wherein at least one recording management area is formed in at least one of the first information recording layer and the second information recording layer and records recording management information which is obtained when test recording is performed for at least one of the first and the second inward test recording areas and the first and the second outward test recording areas, said method comprising:
a first step of determining recording conditions by performing test recording for one of the first inward test recording area and the first outward test recording area in accordance with a requested recording speed when a request for recording information in the first information recording layer is made;
a second step of (i) recording the information in the first information recording layer based on the recording conditions determined in the first step, and (ii) recording management information, obtained when the test recording is performed for one of the first inward test recording area and the first outward test recording area, in the recording management area;
a third step of determining recording conditions by performing test recording for one of the second inward test recording area and the second outward test recording area in accordance with a requested recording speed when a request for recording information in the second information recording layer is made; and
a fourth step of (i) recording the information in the second information recording layer based on the recording conditions determined in the third step, and (ii) recording management information, obtained when the test recording is performed for one of the second inward test recording area and the second outward test recording area, in the recording management area.

14. The optical disk recording method according to claim 13, wherein:
two recording management areas are formed in the first information recording layer and the second first information recording layer,
the two recording management areas comprises a first recording management area formed in the first information recording layer and a second recording management area formed in the second information recording layer,
the second step records recording management information, obtained when the test recording is performed for one of the first inward test recording area and the first outward test recording area in the first step, in the first recording management area, and
the fourth step records recording management information, obtained when the test recording is performed for the second inward test recording are or the second outward test recording area in the third step, in the second recording management area.
